(19) United States
(12) Patent Application Publication
(10) Pub. No.: US 2007/0081332 A1
(43) Pub. Date: Apr. 12, 2007

(54) Strip light structure

(76) Inventor: Zheng Zhong He, Taichung (TW)

Correspondence Address: Liberty Patent and Trademark Office, P.O. Box 590, Taichung City, 400, TW

(21) Appl. No.: 11/210,772

(22) Filed: Aug. 25, 2005

(51) Int. Cl. F21S 13/14

(52) U.S. Cl. 362/252

(57) ABSTRACT

A structure of strip light, comprising a main unit and a plurality of light-emitting devices, wherein the main unit consisting of an insulating unit and a plurality of conductive units, the conductive units being arranged in lines on the insulating unit; the light-emitting devices are respectively connected with the conductive units in line arrangement, forming a matrix circuit. In application, such strip lights have the capability of bending freely and is flexible with reliable connecting circuit for extensive use in all sorts of lighting products and applications.

### BACKGROUND OF THE INVENTION

1. Field of the invention

The present invention relates to a type of strip light structure, particularly to one having a matrix electrical circuit and flexibility for free bending.

2. Description of the Prior Art

Conventionally, a display device made of LED is in the shape of a plane. Such display device has the effect of display, but due to its plane-shaped configuration, it can not be bent in its application. For example, a plane-shaped LED display device is not suitable for installation at the corner of house eaves, or at the corner of an advertising signboard, or the corner of a car body.

However, in daily living, there is indeed the need for the installation of a light-emitting devices at corners for the purpose of caution or identification. Therefore, providing a bendable light-emitting device is satisfactory for practical needs, the light in strip structure is the best option for above applications. But generally, the light-emitting devices on a strip light are arranged in a single line. So, the light-emitting devices in the strip light structure are serially connected. But such type of serially connected circuit not only requires a higher voltage to enable normal functioning of each light-emitting device but also when one of the light-emitting devices in strip light failed will cause entire light fail. Therefore, such structure is not an ideal type.

### SUMMARY OF THE INVENTION

A strip light structure of this invention, comprising a main unit including a plurality of conductive units and an insulating unit; and a plurality of light-emitting devices, having conductive connecting pins, wherein the plurality of conductive units on the main unit are arranged in line, having intervals between the conductive units, the plurality conductive units are used for connecting the conductive pins of the light-emitting devices.

The present invention has a bendable insulating strip, on which are arranged a plurality of strip-shaped conductive units, then a plurality of light-emitting devices(such as Light Emitting Diode) disposed on the plurality conductive units, thereby forming a matrix electrical circuit.

The arrangement of the plurality of conductive units are in two methods. One is to install a plurality of staggered conductive units into two lines on same surface of an insulating unit, or, the plurality of conductive units are arranged into one line with an interval between two neighboring conductive units on two opposite surfaces of the insulating unit, with the opposite conductive units forming a staggered arrangement.

The main objective of this invention is to provide a strip light structure, which is flexible and freely bendable, and has a reliable connecting circuit for extensive satisfaction to all requirements of all sorts of lighting products and applications.

Please refer to the detailed description below of the objectives, performance, preferred embodiments and drawings of the present invention.

### BRIEF DESCRIPTION OF THE DRAWINGS

FIG. 1 is an exterior view of the present invention in a horizontal application.

FIG. 2 is a schematic of electrical circuit of the present invention.

FIG. 3 is a view of the present invention in a curved application.

FIG. 4 is a schematic view of another embodiment of the present invention.

FIG. 5 is a schematic view of further embodiment of the present invention.

FIG. 6 is an exterior view of the present invention in a vertical application.

FIG. 7 is a schematic of electrical circuit of the present invention.

FIG. 8 is a view of the present invention in a curved application.

FIG. 9 is a view of the present invention in another curved application.

FIG. 10 is a view of the present invention in a twisted application.

FIG. 11 is a view of another embodiment of the present invention.

FIG. 12 is a view of a further embodiment of the present invention.

BRIEF DESCRIPTION OF THE NUMERALS

10 strip light
12 main unit
13 insulating unit
14 light-emitting device
15 conductive unit
16 conductive unit
18 interval
19 conductive unit
20 conductive unit
22 connecting pin
24 connecting pin
L1 power source
L2 power source
U1 member
U2 member
U3 member
U4 member
U5 member
U6 member

### DETAILED DESCRIPTION OF THE PREFERRED EMBODIMENT

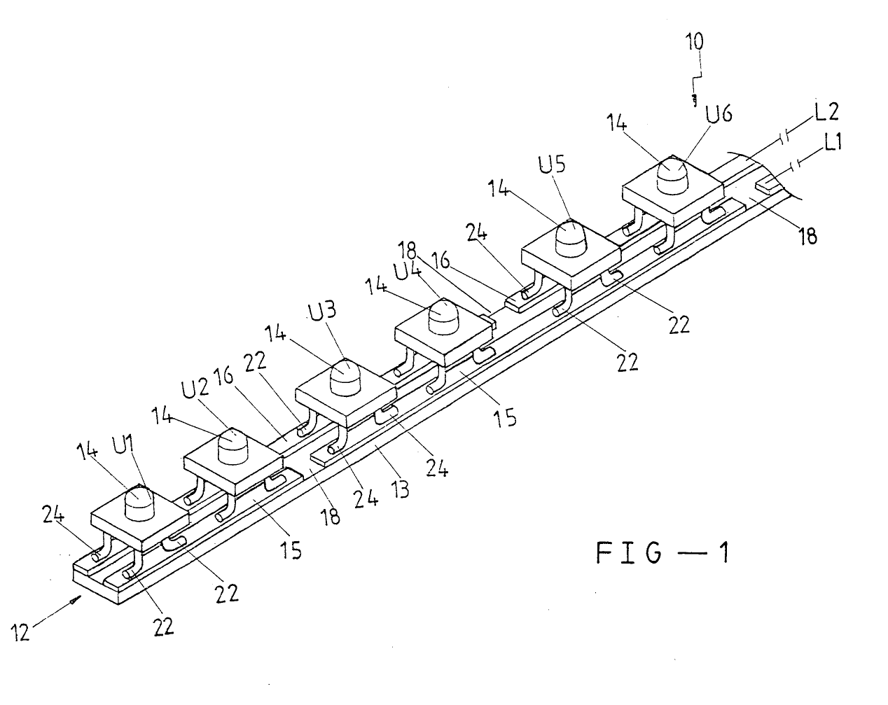

Please refer to FIG. 1 that shows a type of horizontal strip light 10, said strip light 10 comprising a main unit 12 and a plurality of light-emitting devices 14.

The main unit 12 comprises a line-shaped insulating unit 13 and a plurality of strip-shape conductive units 15, 16. Wherein, the strip-shape conductive units 15, 16 are parallel to each other and arranged on the same side of the insulating unit 13. Each of the conductive units 15, 16 contain a plurality of pieces, with an interval 18 positioned between two neighboring conductive units 15,16 on a same line. Each strip-shape conductive unit 15,16 matching the intervals 18 formed on different lines of the conductive units 15,16.

A plurality of light-emitting devices (such as: LED) 14, with conductive connecting pins 22, 24 respectively connected to the conductive units 15, 16 on the main unit 12.

The above insulating unit 13 is bent and made into a thin elongated strip. Each light-emitting device 14 has four connecting pins 22, 24. The connecting pins 22, 24 of each light-emitting device 14 are respectively connected to the two conductive units 15, 16 opposite each other.

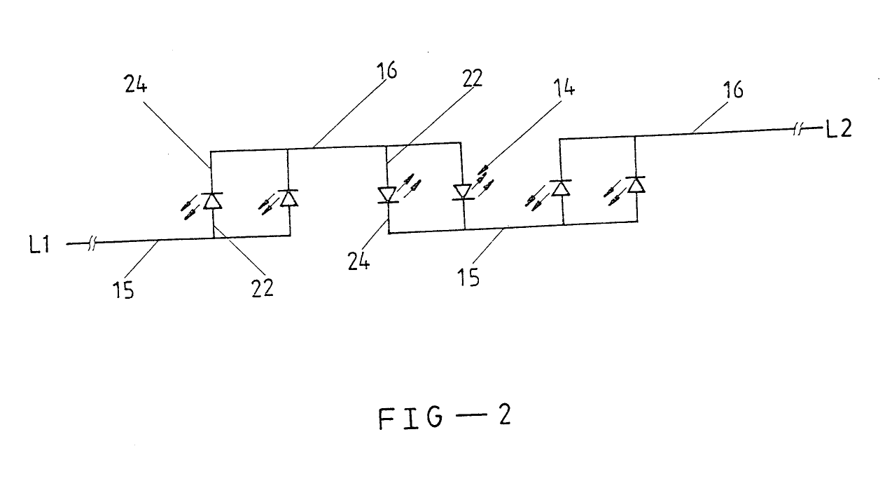

Please refer to FIGS. 1 and 2. Since the conductive unit 15 or conductive unit 16 on one side are separated from each other to form an interval, and the conductive unit 16 or conductive unit 15 on the other side is disposed to opposite the two conductive unit 15 or conductive unit 16 that are separated from each other. When a member U1 of the light-emitting device 14, and two connecting pins 22 of a member U2 are connected with the conductive unit 15, the other two connecting pins 24 are connected with the conductive unit 16; then, the two connecting pins 22 of a member U3 and member U4 are connected with the conductive unit 16, and the other two connecting pins 24 are then again connected with the conductive unit 15; then, two connecting pins 22 of a member U5 and member U6 are then connected with the conductive unit 15, and the other two connecting pins 24 are then again connected with the conductive unit 16. In such a status, the member U1, member U2, member U3, member U4, member U5 and member U6 in the light-emitting device 14 are in parallel connection because their connecting pins 24 are respectively connected to the same conductive unit 15, 16; meanwhile, the member U1, member U2 and the member U3, member U4, and the member U5, member U6 are in serial connection.

According to the above connection, when power source L1, L2 must be respectively connected to the conductive unit 15, 16 at the front and rear ends, all light-emitting device 14 and conductive units 15, 16 connected in a circuit loop.

Therefore, even when part of the LED is defective, it will not result in failure of lighting to the entire strip light 10.

Importantly, the conductive units 15, 16 adopted in the present invention relate to strip-shaped conductive units or other conductive units that are flexible enough to be bent freely and capable of connecting with the connecting pins of the light-emitting device, and in simplified configuration, therefore, during the production process, it can be conveniently fastened to two sides of the insulating unit 13, in order to satisfy the requirement of mass and rapid production of thin configuration.

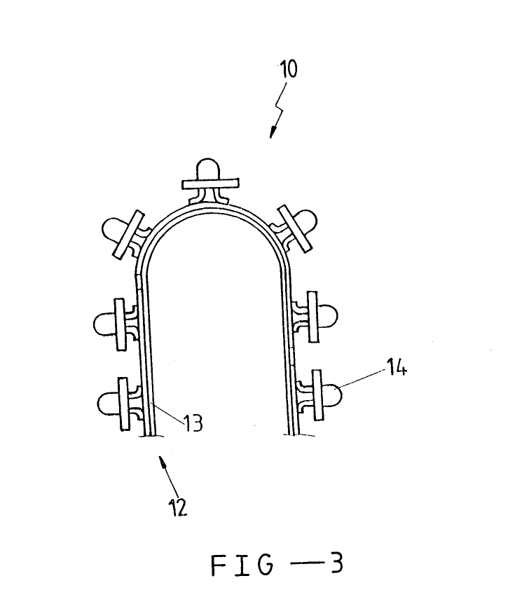

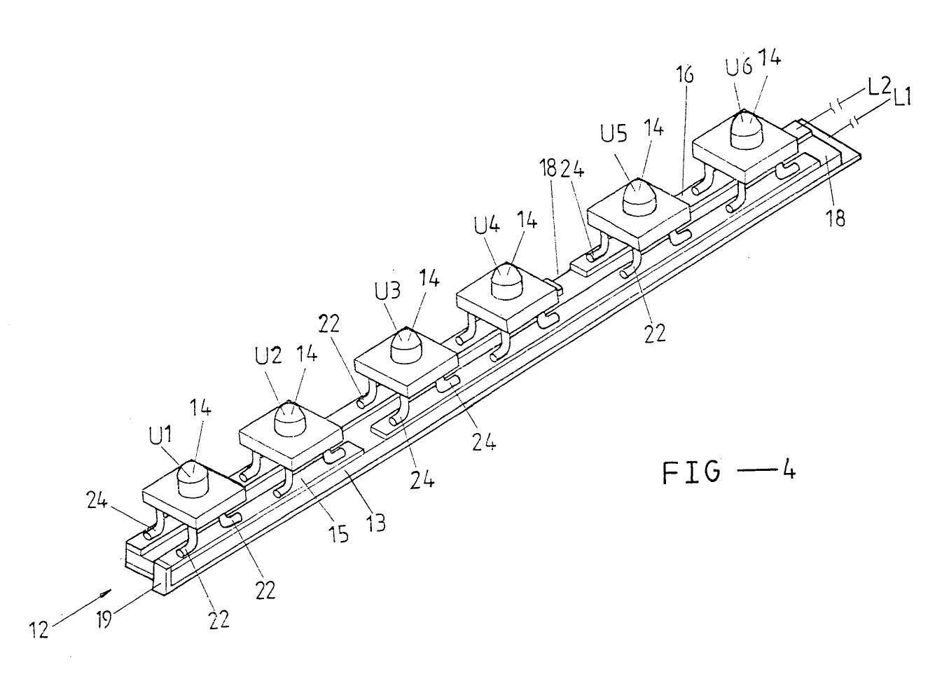

Please refer to FIG. 3, since the insulating unit 13 of the main unit 12 has the capability of being bent freely, and all light-emitting devices 14 are striding on the same side of the main unit 12, the present invention can be bent vertically in application. In its application, the present invention of strip light 10 can be bent and fastened in a corner, such as a corner of house eaves, or a corner on the outside of an advertising signboard. Please refer to FIG. 4, the present invention can have a conductive unit 19 on the other side of the insulating unit 13 of the main unit 12, with the conductive unit 19 connected with the conductive unit 15 or the conductive unit 16, thereby the power source L1, L2 can be connected to one terminal of the conductive unit 15 or conductive unit 16 not connected to the conductive unit 19, to constitute a circuit loop. Therefore, in application, the user only needs to cut a required length of strip light, and short-circuit the conductive unit 19 at the bottom and the conductive unit 15 at the top of its terminal, and 15 connect the other terminal to power source L1, L2 to form a circuit loop, without the need of supplying a power source at both terminals.

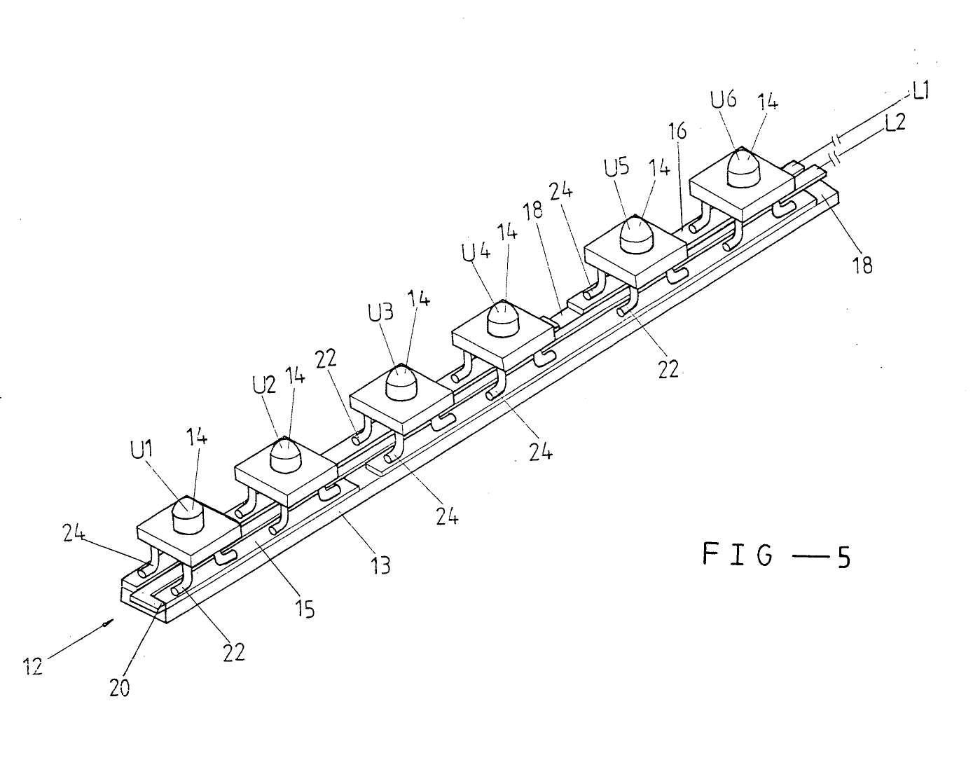

Please refer to FIG. 5, the present invention can also have a conductive unit 20 between the conductive unit 15 and the conductive unit 16 on the same side of the insulating unit 13 of the main unit 12, and connect the conductive unit 20 to the conductive unit 15 or conductive unit 16, thereby the power source L1, L2 can be connected to the conductive unit 15 or conductive unit 16 at one terminal not connected with the conductive unit 20, forming a circuit loop. Therefore, in application, the user needs to only take a required length of strip light, then short-circuit the conductive unit 20 with the conductive unit 16 at a terminal of the strip light, and connect power source L1, L2 to the other terminal to constitute a circuit, without having to supply a power source at two terminals.

It is understandable from the above description that the present invention has the structure of a single-unit matrix circuit, which is capable of being bent in application, but will not fail due to damage to part of the light-emitting device 14, therefore, it has better application performance and the effects of thin shape and lightweight in production.

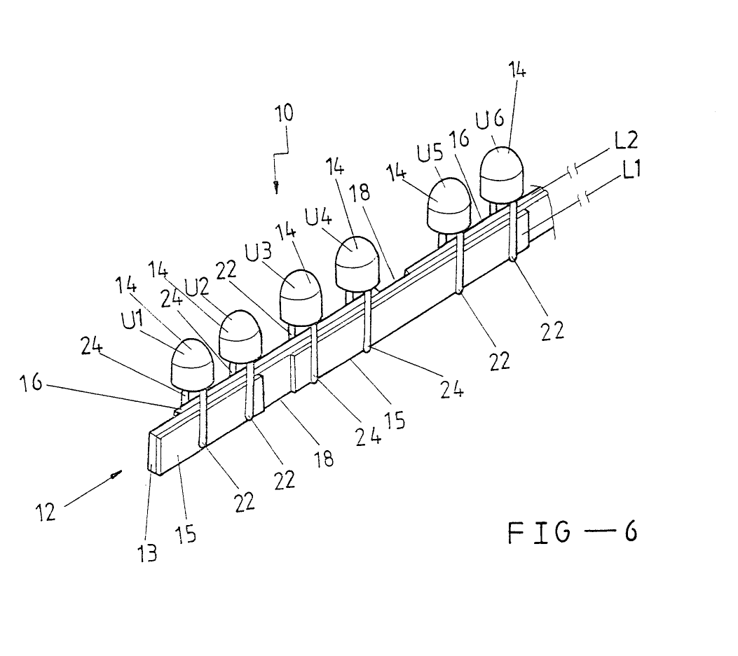

Please refer to FIG. 6 that shows the strip light 10 in a vertical configuration. The strip light 10 include a main unit 12 and a plurality of light-emitting devices 14.

The main unit 12 includes an insulating unit 13 and a plurality of strip-shaped conductive units 15, 16. Wherein, the strip-shape conductive units 15, 16 are respectively disposed on two sides of an insulating unit 13. The conductive units 15 or conductive units 16 on the same side are arranged in a line, with an interval 18 disposed between two neighboring conductive units 15 or 16. Meanwhile, all conductive units 15, 16 are disposed to correspond with intervals 18 formed by conductive units 15,16 on different lines.

A plurality of light-emitting devices (such as LED) 14, their conductive connecting pins 22, 24 are respectively connected with conductive units 15, 16 of the main unit 12.

The insulating unit 13 is bendable and made in the shape of a thin elongated strip. Each light-emitting device 14 has two connecting pins 22, 24; each of the connecting pins 22, 24 of the light-emitting device 14 is respectively connected to the matching two pieces of conductive units 15, 16.

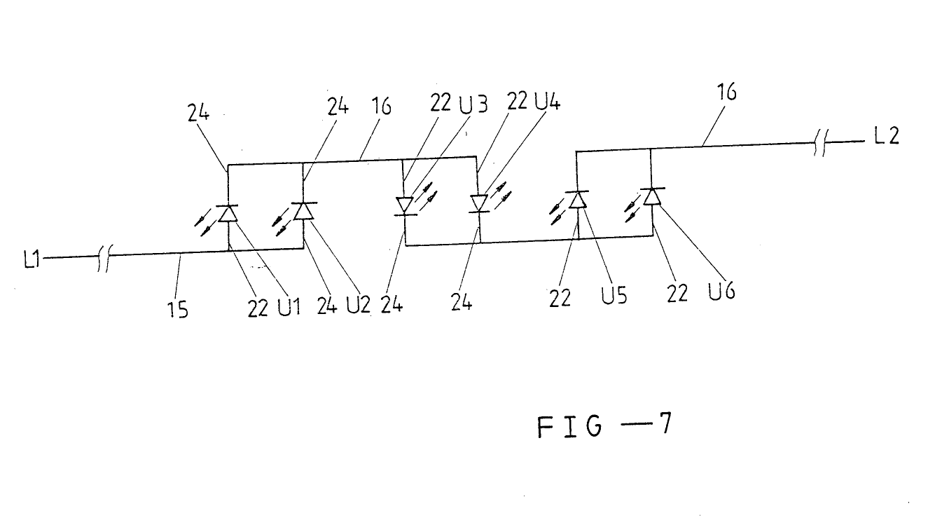

Please refer to FIGS. 6 and 7, since the neighboring conductive units 15 or conductive units 16 on a same side are separated to form intervals, and the opposite conductive units 16 or conductive units 15 are disposed to opposite the two separated conductive units 15 or conductive units 16. When one connecting pin 22 of the member U1, member U2 of the light-emitting device 14 is connected to the conductive unit 15, the other connecting pin 24 is connected with the conductive unit 16; then, one connecting pin 22 of the member U3, member U4 is connected with the conductive unit 16, and the other connecting pin 24 is further connected with the conductive unit 15; one connecting pin 22 of the member U5, member U6 is further connected with the connector 15, and the other connecting pin 24 is further connected with the conductive unit 16; at this stage 14, the member U1, member U2, member U3, member U4, member U5 and member U6 are in parallel connection because their two connecting pins are respectively connected to the same conductive unit 15,16; meanwhile, the member U1 and member U2, and member U3 and member U4, and member U5 and member U6 are connected serially.

According to the above connection, when power source L1,L2 must be respectively connected to the conductive unit 15,16 at front and rear terminals, all light-emitting member 14 and conductive units 15,16 constitute a matrix form of circuit loop. Therefore, even when some part of the LED is defective, it will not result in total failure of the strip light 10.

Importantly, the conductive units 15, 16 adopted in the present invention relate to strip-shaped conductive units or other conductive units that are flexible enough to be bent freely and capable of connecting with the connecting pins of the light-emitting device, and in simplified configuration, therefore, during the production process, it can be conveniently fastened to two sides of the insulating unit 13, in order to satisfy the requirement of mass and rapid production of thin configuration.

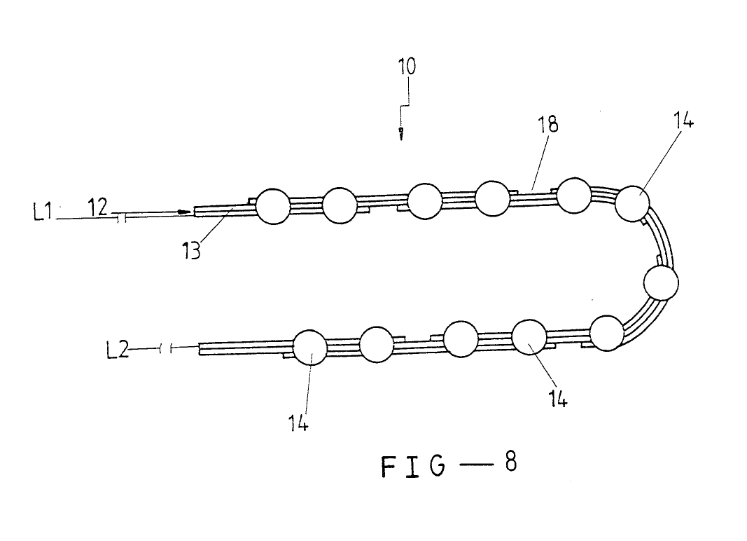

Please refer to FIG. 8, since the insulating unit 13 of the main unit 12 is capable of being bent freely, and the light-emitting device 14 is capable of striding on two sides of the main unit 12, in application, it can be bent horizontally. In application, the strip light 10 can be bent and fastened to a corner, such as a corner of a car body, or a corner of a crossroad.

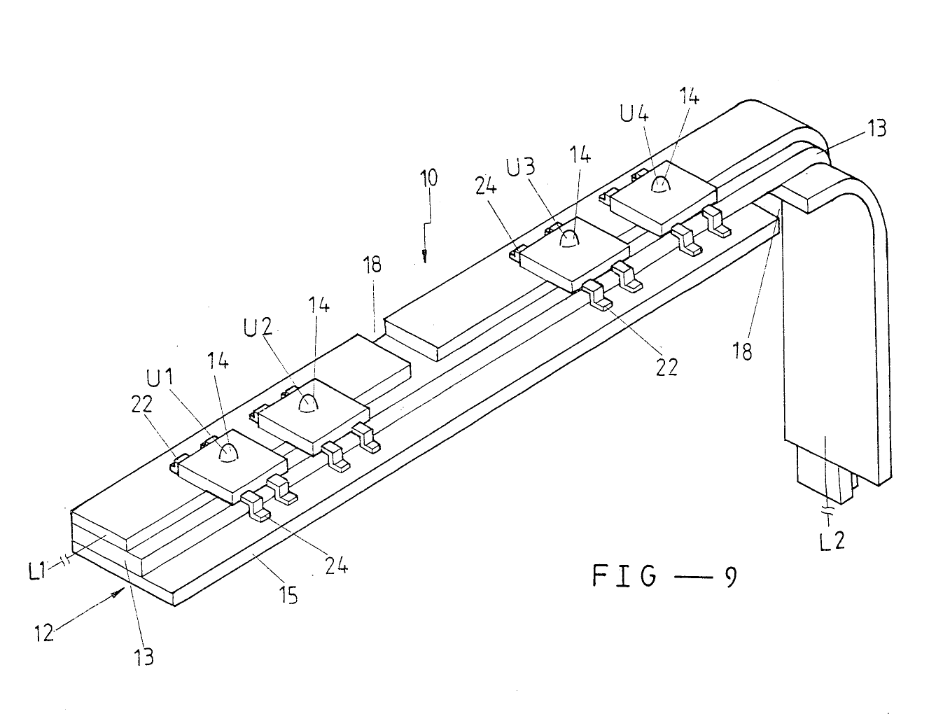

Please refer to FIG. 9, since the insulating unit 13 of the main unit 12 is bendable, and the light-emitting device 14 strides on two sides of the main unit 12, in application, the user can bend it in a vertical direction. In application, the strip light 10 can be bent and fastened in a corner, such as a corner of a car body or a corner of at a crossroad.

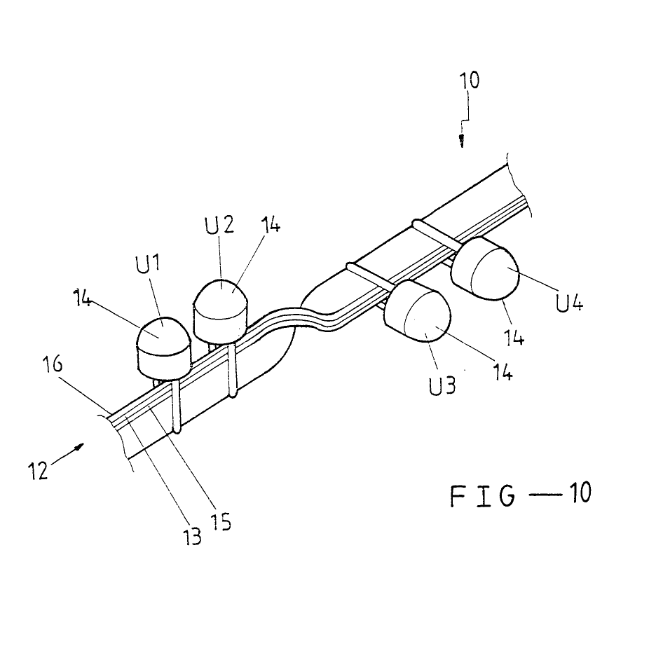

Please refer to FIG. 10, because the main unit is bendable, it is capable of twisting the main unit 12, thereby, the strip light 10 have the function of displaying in more directions, thereby reducing the intervals of the lights and enabling more variations to the application of the strip light 10.

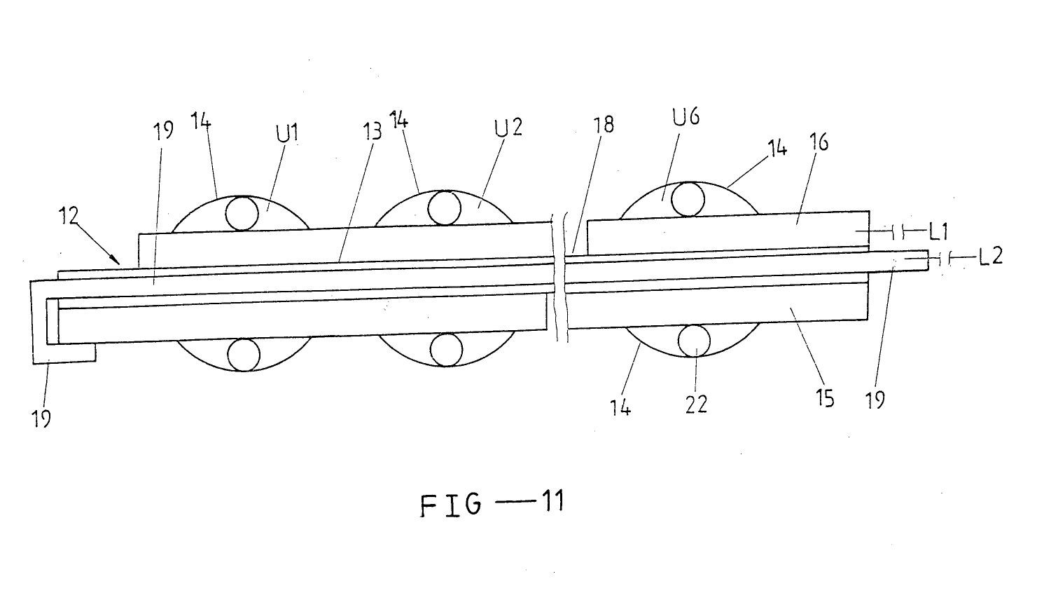

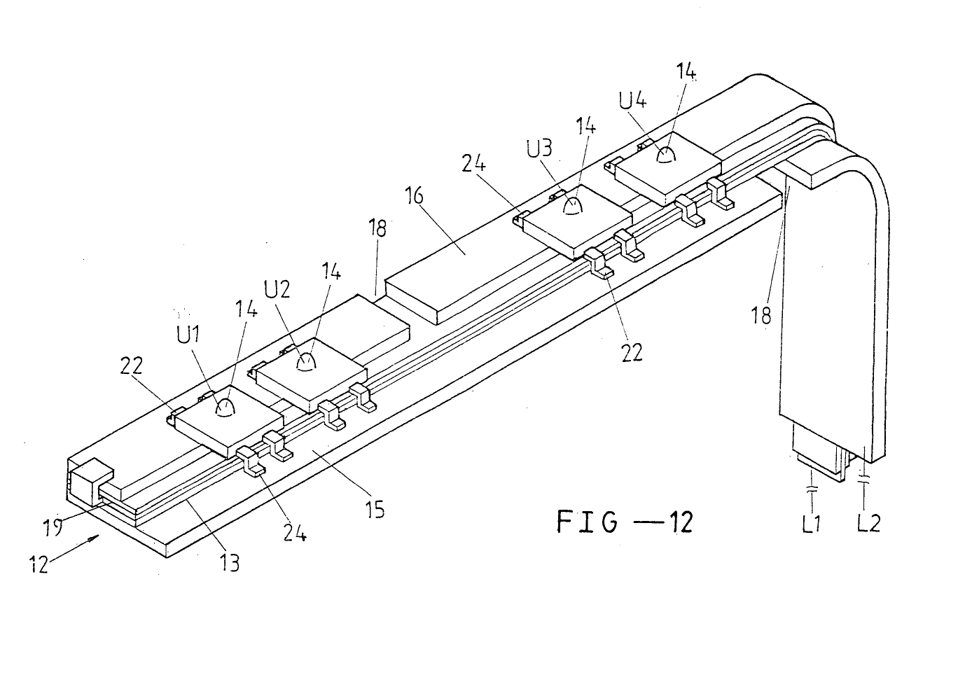

Please refer to FIGS. 11 and 12, the present invention can further have a conductive unit 19 inside the insulating unit 13 of the main unit 12, connecting the conductive unit 19 with the conductive unit 15 or conductive unit 16, thereby the power source L1, L2 can be connected with the conductive unit 15 or conductive unit 16 at one terminal not connected with the conductive unit 19, to constitute a circuit loop. In application, it has similar convenience as shown in FIG. 4 or 5.

From the above description and explanation of the application, it is known that the present invention has a single-unit matrix circuit structure, which is bendable in application, so that it can operate even in case of partial damage to the light-emitting device 14, thereby it has better performance and the effects of thinner and lightweight configuration in production.

It is to be understood that the above description covering the preferred embodiments of the present prevention and design plans are for reference only, which are not used to limit the scope of the present invention, and that all equivalent skills and approaches without departing from the scope of the present invention shall be included in the subject claim.

What is claimed is:

1. A strip light structure, comprising:
a main unit, comprising a plurality of conductive units and an insulating unit; and
a plurality of light-emitting devices, having conductive connecting pins;
wherein the plurality of conductive units on the main unit are arranged in line, having intervals between the conductive units, the plurality conductive units are used for connecting the conductive pins of the light-emitting devices.

2. The strip lights structure of claim 1, wherein the plurality of conductive units are arranged in two lines on the same side of the insulating unit, and disposed to have an interval between two neighboring conductive units of each line.

3. The strip lights structure of claim 1, wherein the plurality of conductive units are arranged on both opposite sides of the insulating unit, the conductive units on each side arranged in one line with an interval between two neighboring conductive units.

4. The strip lights structure of claims 1 and 2, wherein the main unit has one conductive unit, said the conductive unit is disposed on the different side where from the other side of the plurality of conductive units disposed on the insulating unit.

5. The strip lights structure of claim 1 and 2, wherein one conductive unit is provided between the two lines of the plurality of conductive units on the same side of the insulating unit of the main unit.

6. The strip lights structure of claim 1 and 3, wherein one conductive unit enclosed inside the insulating unit of the main unit.
